(19) United States
(12) Patent Application Publication
(10) Pub. No.: US 2010/0218388 A1
(43) Pub. Date: Sep. 2, 2010

(54) CHAINSAW THROTTLE AND BRAKE MECHANISMS

(76) Inventor: Kent Myers, Magnolia, OH (US)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 12/526,153

(22) PCT Filed: Nov. 10, 2006
(86) PCT No.: PCT/US2006/044012

§ 371 Date: Apr. 13, 2010

(51) Int. Cl. B27B 17/02; F16D 49/10; B25F 5/00

(52) U.S. Cl. 30/383; 188/77 W; 173/170

(57) ABSTRACT

Chainsaws are provided, each having a brake band disposed about a drum that rotates during advancement of the saw chain about the saw bar. An end of the brake band is biased to a position that draws the brake band tight about the drum to prevent advancement of the saw chain, and the throttle trigger of the chainsaw is associated with this biased end to push the band against the bias and release the drum when the throttle trigger is squeezed to drive the elements of the chainsaw that serve to advance the saw chain. Also provided are new concepts for associating gasing and braking elements with the throttle trigger.

### TECHNICAL FIELD

The present invention generally relates to chainsaws, and, more particularly, relates to braking mechanisms and throttle trigger mechanisms for providing added safety features to typical chainsaws, reducing chain run down time and finger fatigue.

### BACKGROUND ART

Chainsaws are potentially dangerous tools even when operators exercise extreme caution during their use. Over the years, chainsaws have been manufactured to include braking mechanisms that are intended to function to stop the rotation of the saw chain about the saw bar in the event that the saw bar and the chain thereabout kick backwards toward the operator. These “kickback” brakes operate either through centrifugal forces or through impact of a hand guard with the operator's support arm used to support and maneuver the chainsaw. In either case, the kickback brakes operate through the movement of various elements from active positions, where the saw chain is permitted to rotate about the saw bar, to brake positions, where the saw chain is braked. When the kickback brakes are activated, the saw chain is stopped through well-known typically spring biased mechanisms.

When kickback brakes are activated to stop the saw chain, they are typically activated when the operator is running the saw chain at full throttle. And the components of the chainsaw that engage to stop the saw chain do so while those components are driven at top speeds.

Chainsaws also typically operate in such a manner that the saw chain may continue to rotate about the saw bar when the operator has let up on the throttle. This is generally known as chain run down. And even when the throttle is fully released, there is a chance that the saw chain may be moving at a rate fast enough to be dangerous. Attempts have therefor been made to associate components of the braking mechanism with the throttle to brake the saw chain upon release of the throttle and release the saw chain from the braked state upon squeezing the throttle. It is believed that these attempts have failed because they provide a chainsaw having a throttle that is too difficult to squeeze and keep depressed, leading to great finger fatigue. These designs also hurt an operator's trigger finger when the kickback braking mechanism is activated. An example of such a chainsaw is provided in U.S. Pat. No. 4,683,660, wherein a link extends from components of the kickback braking mechanism to the throttle such that squeezing the throttle pulls on the braking mechanism to release its braking of the saw chain, and letting up on the throttle allows the braking mechanism to return to a position that stops the moving saw chain. Other chainsaw embodiments are provided in U.S. Pat. Nos. 4,594,780; 4,753,012; 5,813,123; and 6,842,987. In at least some of these prior art embodiments, the braking mechanism components are associated with the kickback brake, and, when the operator trips the kickback brake, the braking mechanisms force the throttle trigger to its normal non-squeezed position, causing the operator's finger to be uncomfortably forced open. This trigger kickback contributes to finger fatigue, which is a very big concern, particularly for professionals that must operate chainsaws for their maximum suggested running times.

Although the prior art has addressed the inherent dangers in operating a chainsaw and has provided mechanisms in an attempt to make chainsaw operation safer, a need still exists for new safety mechanisms that are more reliable and safe not only for the operator but for the chainsaw as well. A need exists to provide chainsaws that reduce chain run down. A need also exists for reducing finger fatigue. A further need exists for a chainsaw that brakes the saw chain upon release of the throttle trigger, but does not suffer from trigger kickback upon tripping the kickback brake.

### SUMMARY OF THE INVENTION

With a chainsaw of a first type, a first embodiment of this invention provides a chainsaw comprising a brake cable; and a throttle control mechanism including a throttle control trigger rotating at a pivot point between an off throttle position and an on throttle position, a freewheeling cam providing a ratchet tooth, wherein said brake cable is secured to said freewheeling cam; and an actuator arm associated with said throttle control trigger to rotate therewith, said actuator arm engaging said ratchet tooth of said freewheeling cam such that rotation of said throttle control trigger from said off throttle position to said on throttle position causes movement of said freewheeling cam through the engagement with said actuator arm, and movement of said freewheeling cam causes movement of said brake cable.

In another embodiment of the chainsaw of a first type, this invention provides a chainsaw comprising a brake drum; a saw bar; an saw chain disposed about said saw bar, wherein rotation of said brake drum at sufficient velocity causes said saw chain to be advanced about said saw bar; a biasing mechanism; a brake band disposed around said brake drum and having a brake end that is associated with said biasing mechanism and biased thereby to draw said brake band against said brake drum and prevent the rotation thereof; a brake cable; and a throttle control mechanism including a throttle control trigger rotating at a pivot point between an off throttle position and an on throttle position, a freewheeling cam providing a ratchet tooth, wherein said brake cable is secured between said freewheeling cam and said biasing mechanism; and an actuator arm associated with said throttle control trigger to rotate therewith, said actuator arm engaging said ratchet tooth of said freewheeling cam such that rotation of said throttle control trigger from said off throttle position to said on throttle position causes movement of said freewheeling cam through the engagement with said actuator arm, and movement of said freewheeling cam causes movement of said brake cable to overcome the bias of said biasing mechanism and space said brake band from said brake drum.

With a chainsaw of a second type, a second embodiment of this invention provides advantages in a chainsaw comprising a brake drum; a saw bar; a saw chain disposed about said saw bar, wherein rotation of said brake drum at sufficient velocity causes said saw chain to be advanced about said saw bar; and a brake band disposed around said brake drum for braking the same. In accordance with this embodiment, the brake band includes a first movable end that is associated with a first biasing member and an independent second movable end that is biased by a second biasing member to draw said brake band against said brake drum and thereby prevent the rotation of said brake drum, i.e., chain run down. A throttle control trigger is operatively associated with said second movable end of said brake band and has an off throttle position and an on throttle position, wherein, when said throttle control trigger is moved from said off throttle position to said on throttle position, said second movable end moves against said second biasing member, thereby loosening said brake band from said brake drum and permitting the rotation of said brake drum, and, when said throttle control trigger is moved from said on throttle position to said off throttle position, said second movable end is moved by said second biasing member to draw said brake band against said brake drum and thereby prevent the rotation of said brake drum, i.e., chain run down.

Chainsaws of both types are improved by yet another embodiment of this invention providing a chainsaw comprising a throttle control trigger rotating at a pivot point between an off throttle position and an on throttle position; an arced brake control associated with said throttle control trigger; a cable secured to said arced brake control such that rotation of said throttle control trigger from said off throttle position to said on throttle position causes a portion of said cable to be wound on a perimeter of said arced brake control.

### BRIEF DESCRIPTION OF THE DRAWINGS

For a complete understanding of the objects, embodiments and structure features of the present invention, reference should be made to the following detailed description and accompanying drawings wherein

FIG. 1 is a side view of a chainsaw in accordance with this invention, shown with the throttle control trigger in the released position;

FIG. 2 is a side view of a chainsaw in accordance with this invention, shown with the throttle control trigger squeezed but released from an associated freewheeling cam such that the trigger is essentially temporarily disconnected from the major functioning elements of the chainsaw;

FIG. 3 is a side view of the assembly of the throttle trigger and associated elements of a chainsaw in accordance with this invention;

FIG. 4 is a side view of the throttle trigger of FIG. 3, shown partially assembled;

FIG. 5 is a side view of the throttle trigger of FIG. 3, shown fully assembled with connections to a braking cable and throttle rod;

FIG. 6 is a schematic view of prior art throttle control mechanisms employing lever arms;

FIG. 7 is a schematic view of an embodiment of a throttle control mechanism in accordance with a preferred embodiment of this invention, employing what is termed herein as an “arced brake control;”

FIG. 8 is a side view of a chainsaw in accordance with this invention, shown with the throttle control trigger in the released (i.e., off throttle) position;

FIG. 9 is a side view of a chainsaw in accordance with this invention, shown with the throttle control trigger in an activated (i.e., on throttle) position;

FIG. 10 is a side view of the braking mechanics of a chainsaw in accordance with this invention, shown as viewed in an “outboard” type cover plate and shown with the throttle control trigger in the released position, i.e., off throttle, and it should be understood that such braking mechanics may be practiced in an “inboard” configuration as well;

FIG. 11 is a side view of the braking mechanics of a chainsaw in accordance with this invention, shown as viewed in an outboard type cover plate and in an on throttle position, and it should be understood that such braking mechanics may be practiced in an inboard configuration as well;

FIG. 12 is a side view of the braking mechanics of a chainsaw in accordance with this invention, shown as viewed in an outboard type cover plate and in an on throttle position, wherein the front hand guard has been activated;

FIG. 13 is a side view of an alternative embodiment for associating the elements of the braking mechanism of this invention with a user-operable lever that is separate from the throttle control trigger;

FIG. 14 is a schematic view of another embodiment of an “arced brake control” throttle control mechanism of this invention, shown in a first position; and

FIG. 15 is a schematic view of the throttle control mechanism of FIG. 14, shown in a second position.

### BRIEF DESCRIPTION OF THE PREFERRED EMBODIMENTS

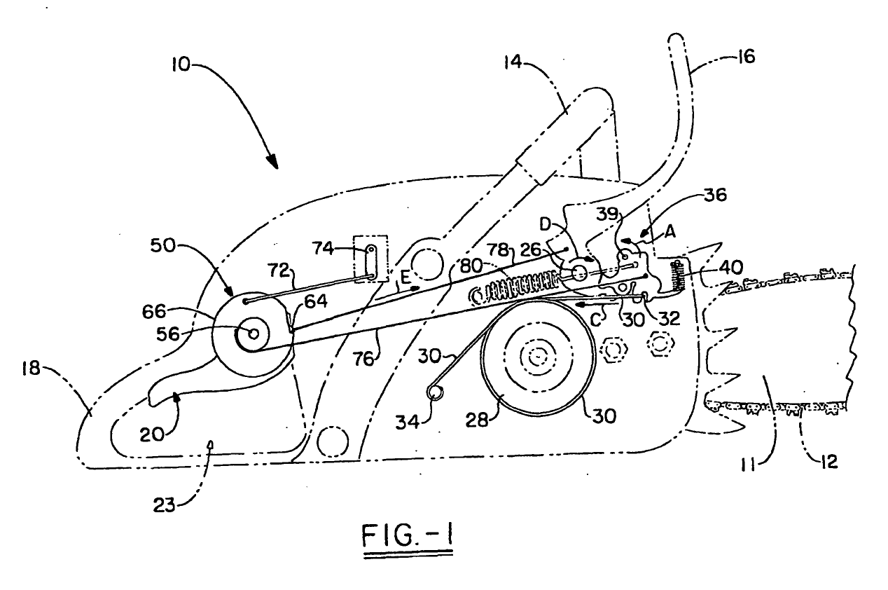

A first embodiment of this invention is particularly adaptable to chainsaws of a first type. Referring now to FIG. 1, a chainsaw (or power saw) in accordance with this first embodiment is shown and designated by the numeral 10. Chainsaw 10 includes saw bar 11 about which saw chain 12 advances. Handle frame 14 is secured to the main body of chainsaw 10, with kick back guard 16 located in front of it. Rear handle 18 is provided for gripping chainsaw 10 and providing access to throttle control trigger 20, which is shown in the normal off throttle position, at handle opening 23. As known, a component cover plate covers and/or houses (explained below) components controlling the advancement of saw chain 12 about saw bar 11, and also covers and/or houses braking mechanisms to control saw chain 12. These braking mechanisms are actuated by kickback guard 16, when it is moved forward about pivot point 26, whether by inertia or by contacting the operator's arm positioned at handle frame 14. This is all conventional and well-known prior art. The cover plate is intentionally not identified in the figures because, depending upon the particular chainsaw configuration being practiced, the figures provided could be considered as having the cover plate removed to show components behind the cover plate and secured to the main body of the chainsaw or may be considered as having the cover plate in place, but see-through, to show components secured to the cover plate. This is explained more fully below with respect to “inboard” and “outboard” chainsaw configurations well known in the art.

Chainsaws are primarily provided in two well-known configurations, termed “inboard” and “outboard,” which refer to the location of the brake band and the kickback braking mechanisms that are associated with the kickback guard. In inboard configurations, the brake band and kickback braking mechanisms are secured in the main body of the saw, behind the cover plate. In outboard configurations, the brake band and braking mechanisms are secured to the backside of the cover plate. It will be readily apparent how this invention will be practiced with either the inboard or outboard configuration, although the inboard configuration is shown here. Additionally, it will be appreciated that different kickback braking mechanisms are provided in different chainsaws, and, although a particular configuration is shown, it will be readily apparent how this first embodiment will be practiced with other braking mechanisms. Typically, these braking mechanisms work through the movement of lever arms and spring biased members when the kickback brake is activated through the movement of the kickback guard.

In the prior art, the saw chain is operatively connected to a brake drum, and the brake drum rotated as the saw chain is advanced around the saw bar. Typically, the brake drum is rotated by a centrifugal clutch that advances the saw chain around the saw bar, but the present invention is not limited thereto or thereby. As known, the centrifugal clutch is activated by squeezing the throttle trigger. A brake band is disposed around the brake drum, and is secured to the main body of the saw at one end, while being secured at its other end to movable braking mechanism components associated with the kickback brake guard.

In chainsaw embodiments of the type that are to specifically benefit from the practice of this embodiment, the brake band is normally biased to be drawn tight against the brake drum to prevent its rotation, thus preventing the advancement of the saw chain about the saw bar, i.e., chain run down. This bias must be overcome to loosen the brake band from about the brake drum to permit advancement of the chain. Thus, one end of the brake band is operationally associated with the throttle control trigger through a cable and lever arm such that squeezing the throttle control trigger moves that end of the brake band to loosen the brake band from about the brake drum. When the throttle control trigger is squeezed to provide power to advance the chain, the brake drum is released from the braked state. When the throttle control trigger is released, the brake band is moved by the bias force back to its normal position, wherein the brake drum is engaged by the brake band and prevented from rotating. Regardless of whether or not the throttle control trigger is squeezed, activating the kickback brake through movement of the kickback guard pulls on the brake band to tighten it about the brake drum and prevent further advancement of the saw chain about the saw bar. This is generally disclosed in U.S. Pat. Nos. 4,594,780; 4,683,660; 4,753,012; 5,813,123; and 6,842,987. Thus, this is all well-known to those of ordinary skill in the art, and it is from these well-known configurations that the present invention departs in order to provide benefits heretofore never realized in the chainsaw arts.

Particularly, in the type of chainsaw generally discussed above, tripping the kickback braking mechanism moves the lever arm associated with the brake band and, thus, moves the cable that connects to the throttle control trigger. This causes the throttle control mechanism to be forced to its normal non-squeezed position at the same time that the end of the brake band is moved to draw the brake band against the brake drum. The throttle control trigger is thus forced against the operators fingers, which are typically squeezing the throttle control trigger at full throttle. This can be painful and certainly increases finger fatigue.

This first embodiment provides a new throttle control mechanism that alters the manner in which the throttle control trigger, the brake band, and the kickback braking mechanisms are structurally interrelated in these types of chainsaws. It reduces the finger fatigue experienced when squeezing the throttle control trigger to overcome the bias that draws the brake band against the brake drum. It also prevents the kickback braking mechanisms from forcing the throttle control trigger to the non-squeezed position when the kickback brake is activated. More particularly, a freewheeling cam is associated with the throttle control trigger, the throttle rod, the brake band and the kickback braking mechanisms to reduce finger fatigue and completely release the throttle control trigger from the elements of the kickback braking mechanism when the kickback brake is activated. Thus, there is no shock to the trigger finger and the kickback braking mechanism operates independently of the new throttle control mechanism.

With reference to FIG. 1, this embodiment is described in its normal off throttle position (i.e., trigger 20 is not squeezed to drive chain 12). In FIG. 1, one may assume that they are either looking at components behind a cover plate and secured to the main body of chainsaw 10 (as in an inboard embodiment), or one may consider that the components shown are secured to a cover plate (as in an outboard embodiment), with the cover plate being see-through in the figures. In either an inboard or outboard embodiment, brake drum 28 is provided in the main body of chainsaw 10. Brake drum 28 is rotated by the squeezing of throttle control trigger 20, and this rotation activates a centrifugal clutch that advances saw chain 12 about saw bar 11. Brake band 30 is disposed around brake drum 28, and is secured to other components of chainsaw 10 at movable end 32 and stationary end 34. Movable end 32 is connected to braking mechanism 36 at lever arm 38, which is biased in the direction of arrow A about pivot point 39 by compression spring 40. In the off throttle position, the bias of spring 40 pulls brake band 30 against drum 28 independent of spring 80 (mentioned below) and with enough force to prevent the rotation thereof, thus preventing the advancement of chain 12, i.e., chain run down. The position of lever arm 38 is limited by the interaction of other components of braking mechanism 36 as generally known.

It should be appreciated that the detailed configuration of the various elements of braking mechanism 36 may change from one chainsaw to another, particularly when considering chainsaws produced by different manufacturers. Thus, herein, the general knowledge of those of ordinary skill in the art is relied upon, and detailed configurations beyond that necessary to comprehend the functioning and practice of the present invention are not drawn and particularly disclosed. It is sufficient to understand that brake band 30 is biased by elements of braking mechanism 36 to engage brake drum 28 when throttle control trigger 20 is at its normal off throttle position. With this understanding, the elements and functioning of the throttle control mechanism of this embodiment is disclosed below.

A throttle control mechanism in accordance with this embodiment is shown and designated by numeral 50, and includes throttle control trigger 20. Optionally, trigger 20 may be longer than the triggers of the prior art, which typically provide room for one trigger finger. By making trigger 20 longer, the operator may squeeze trigger 20 with one or more fingers, reducing finger fatigue due to the mechanical advantage realized from the longer trigger. Finger fatigue can be additionally reduced through what is termed herein an “arced brake control,” explained later in this disclosure.

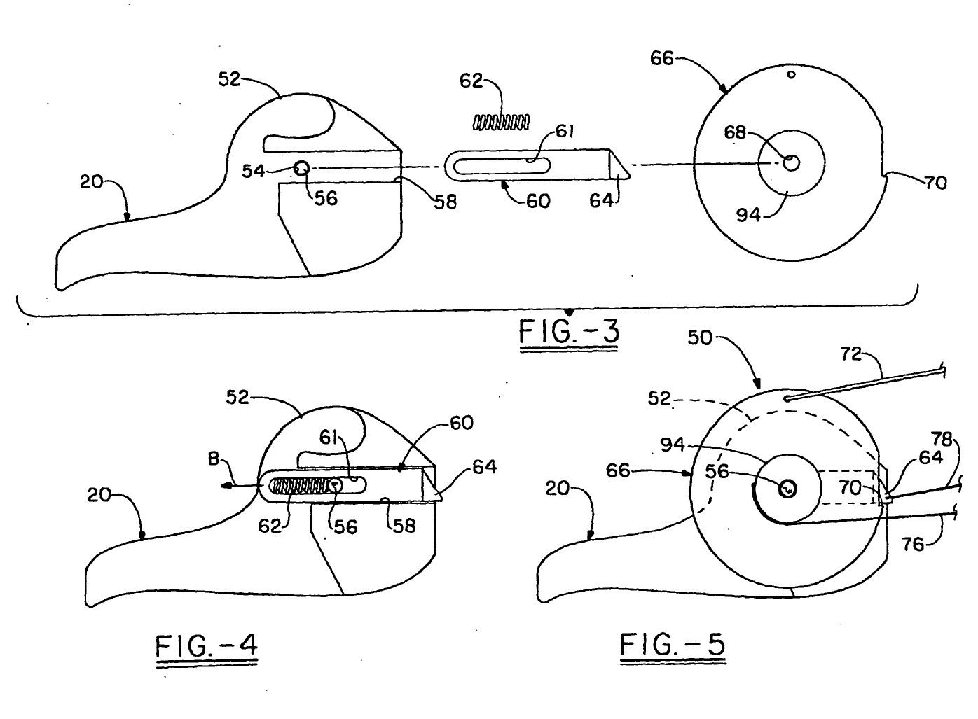

With reference to FIGS. 3-5, trigger 20 extends from body portion 52, which includes aperture 54 in channel 58. Aperture 54 fits over throttle pivot pin 56, which is secured to the main body of chainsaw 10, and the elements of throttle control mechanism 50 rotate about throttle pivot pin 56 when trigger 20 is squeezed and released. Trigger 20 and body portion 52 are biased to the normal off throttle position in a known manner. Actuator bar 60 includes a slot 61 and fits over pin 56, within channel 58, and is biased in the direction of arrow B by actuator biasing member 62. In this embodiment, a spring is employed as biasing member, but it should be appreciated that other suitable biasing members and structures could be employed. Tooth 64 extends outwardly from the end of actuator bar 60 to engage freewheeling cam 66, which fits against body portion 52 and actuator bar 60 by fitting on pin 56 through cam aperture 68. Because the position of actuator bar 60 is maintained by spring 62, tooth 64 normally stays engaged with step 70 and, thus, squeezing trigger 20 to rotate throttle control mechanism 50 about pin 56 causes tooth 64 to push on step 70 and rotate freewheeling cam 66, which, as it's name implies, is freewheeling on pin 56 and would not otherwise advance upon the squeezing of trigger 20.

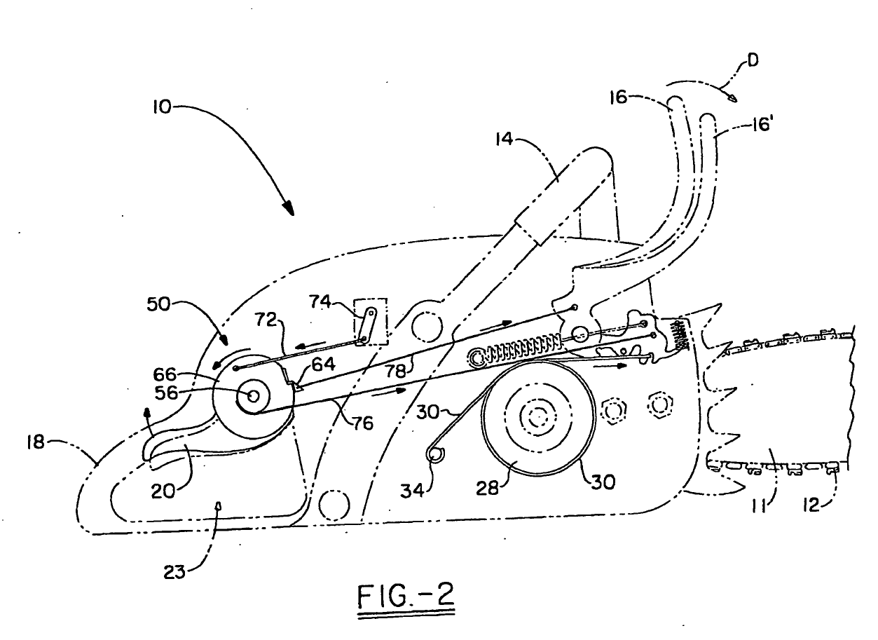

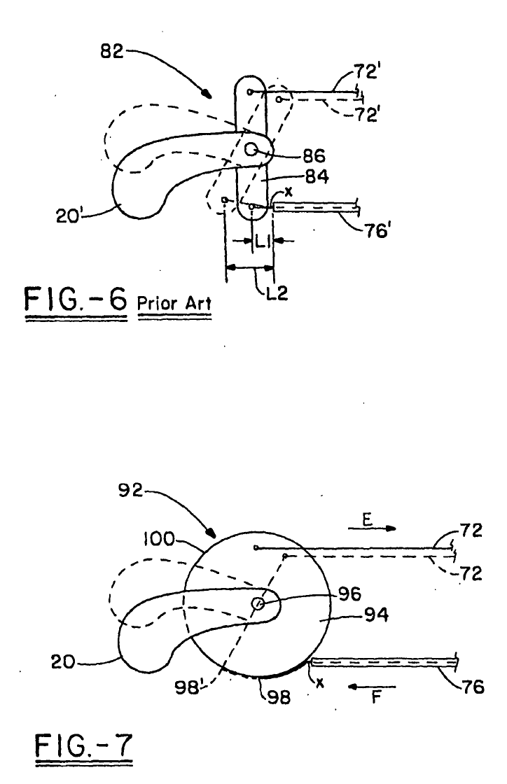

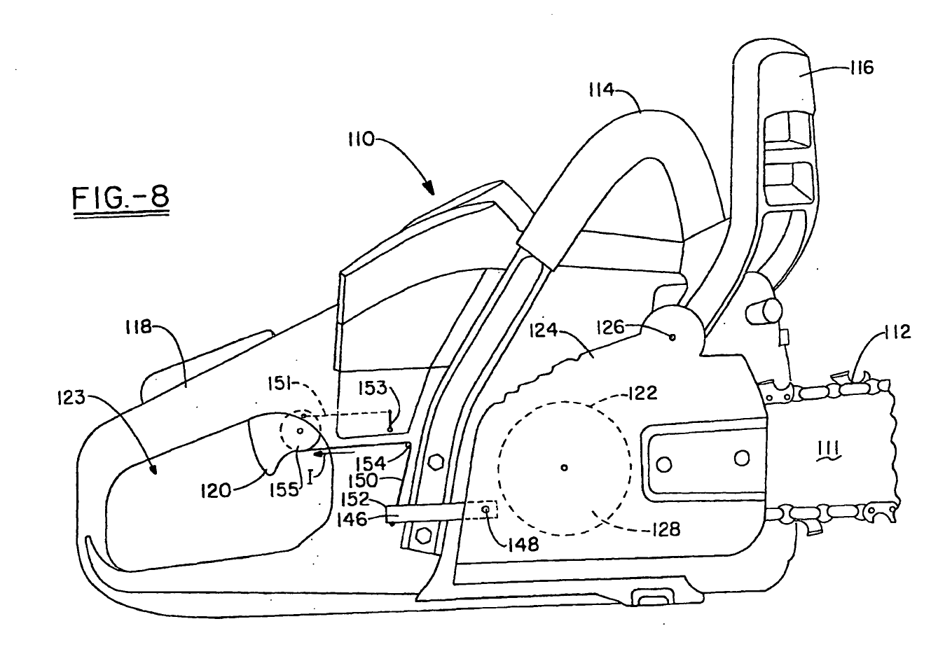

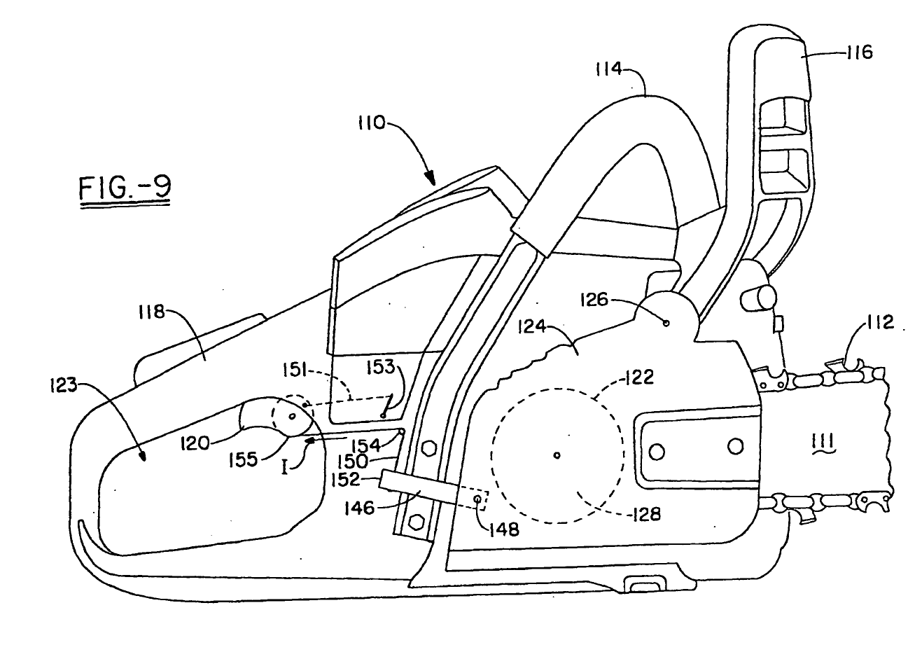

Throttle rod 72 is connected between freewheeling cam 66 and carburetor 74 (FIGS. 1 and 2), and brake cable 76 connects between cam 66 and elements of braking mechanism 36 so that squeezing trigger 20 pushes throttle rod 72 to provide power to drive drum 28, as known, and pulls cable 76 to manipulate elements of braking mechanism 36 to overcome the bias on brake band 30 and release it from its engagement with brake drum 28. In the embodiment shown, brake cable 76 is secured to be pulled by an “arced brake control,” designated by the numeral 94 and functionally discussed more particularly below with reference to FIGS. 6 and 7. It should be appreciated that this is merely preferred, and brake cable 76 could be secured to a specific point on cam 66 or to a lever arm, as discussed with reference to FIG. 6. In the broadest sense, brake cable 76 is secured to elements of braking mechanism 36 so that squeezing trigger 20 and pulling cable 76 overcomes the bias acting on brake band 30 and thus loosens it from around brake drum 28.

Here, cable 76 is secured to lever arm 38, and squeezing trigger 20 causes brake cable 76 to pull on lever arm 38, about pivot pin 39 and against spring 40, moving movable end 32 of brake band 30 in the direction of arrow C and distancing brake band 30 from drum 28, thereby releasing drum 28 from the braked state. By connecting brake cable 76 to throttle control mechanism 50 in this manner, an active position, wherein the saw chain may be advanced about the saw bar, is achieved upon pulling trigger 20 to provide the driving force to the saw chain, and the braking position is achieved upon release of trigger 20 or, independently, upon activation of kickback braking mechanisms, typically through movement of hand guard 16.

In the prior art chainsaw configurations that associate the throttle trigger with the brake band to release the brake drum from the braked state upon squeezing the trigger and brake the brake drum upon release of the trigger, when the operator trips the kickback brake, the braking mechanisms (usually a large, strong spring, such as spring 80, and associated lever arms) force the throttle trigger to its normal non-squeezed position, causing the operator's finger to be uncomfortably forced open. With these types of chainsaws, embodiments of this invention can be employed to prevent this from occurring by further associating actuator bar 60 with kickback guard 16.

With reference to FIGS. 1, 2 and 5, it can be seen that trigger release cable 78 attaches between kickback guard 16 and actuator bar 60. Recalling that actuator bar 60 is spring biased to keep tooth 64 engaged with step 70, tripping kickback braking mechanism 36 by rotating kickback guard 16 in the direction of arrow D (FIGS. 1 and 2) to the position of 16′ pulls trigger release cable 78 in the direction of arrow E, thus pulling actuator bar 60 to disengage tooth 64 from step 70. This releases freewheeling cam 66 from trigger 20, and cam 66 and brake band 30 are pulled by brake cable 76 and spring 40 to their normal rest positions pulling brake band 30 against drum 28 to prevent its rotation and moving throttle rod 72 to close the carburetor and stop the driving of the centrifugal clutch. Such movements are represented by the unlabeled arrows in FIG. 2. Resetting kickback guard 16 permits spring 62 to pull actuator bar 60 and tooth 64 against cam 66, and releasing trigger 20 allows actuator bar 60 to be brought into orientation to engage step 70. Thus, there is no force on an operator's finger when the kickback brake is activated, as in prior art chainsaws that attempted to associate movement of the brake band with movement of the trigger. This is one way in which the present invention addresses finger fatigue and shock to the trigger finger. It should be appreciated that “actuator bar” is to interpreted very broadly because virtually any structure rotating about a pivot point may be used to engage and press against the freewheeling cam of the throttle control mechanism. And although a particular pivot point and element orientation was chosen for disclosure, other orientations and pivot points could be used to cause the actuator bar to releasably contact the freewheeling cam as desired. In other chainsaw embodiments in accordance with this invention, finger fatigue is further reduced through the use of what is termed herein an “arced brake control.”

In particularly preferred embodiments, the connection between throttle control mechanism 50 and brake cable 76 is configured to provide advantages over prior art connections. FIG. 6 is provided to show the general configuration of the prior art, and FIG. 7 is provided to show the configuration provided in accordance with this invention. These figures are minimized to show only the relevant elements. How this concept is practiced in throttle control mechanism 50 should be readily apparent by the identification of arced brake control 94 in mechanism 50. Thus, in FIG. 6, which is to generally depict a prior art chainsaw that employs a cable to be pulled by the pulling of the throttle control mechanism, namely U.S. Pat. No. 4,683,660, cable 76′ is operatively connected to throttle control mechanism 82 through a lever arm 84, which shares a common pivot point 86 with throttle control trigger 20′. In order to help disclose the advances provided by the preferred connection means of this invention, cable 76′ is considered to be fixed at point “X” shown in FIG. 6. When throttle control mechanism 82 is squeezed, cable 76′ is pulled to a new position defined by the movement of lever arm 84. Such a position is shown in phantom in FIG. 6, and the distance cable 76′ is pulled is the difference between the length of cable extending from X to the lever arm 84 (herein measured between the lines defining L1) in the pre-squeezed position and the length extending from X to lever arm 84 (herein measured between the lines defining L2) in the squeezed position. Notably, cable 76′ always extends in a straight line from fixed end X to lever arm 84. Thus, the length between L1 could be compared to the length between L2 to determine the actual distance that cable 76′ is pulled. And although the connection point of cable 76′ on lever arm 84 travels through an arc, the distance that cable 70 is pulled is defined by the straight lines mentioned above.

Referring now to FIG. 7, it can be seen that the lever arm of the prior art (e.g., lever arm 84) is replaced by what is referred to herein as an “arced brake control” 94, which pivots with throttle control mechanism 92 at pivot point 96. Cable 76 extends from a fixed point designated at “X” to connection 98 at the periphery 100 of arced brake control 94. Thus, when throttle control mechanism 92 is squeezed, cable 76 is pulled to a new position (98′) that is defined by the amount of cable 76 taken up by the periphery 100 of arced brake control 94. Thus, even when the distance between pivot point 96 and the connection of cable 76 to arced brake control 94 is the same as the distance between pivot point 86 and the connection of cable 76 to lever arm 84, squeezing throttle control mechanism 92 the same distance as throttle control mechanism 82 causes cable 76 to be pulled further than cable 76′ because cable 76 must wind around arced brake control 94. In order to configure a lever arm 84 to pull the same length of cable as pulled by arced brake control 94, lever arm 84 must be extended, and the extension will result in requiring a greater deal of force against the throttle control trigger to pull cable 76′. Thus, the preferred arced brake control 94 of FIG. 7 permits more cable to be pulled at a lesser pulling force than the lever arms of the prior art.

Throttle rods 72 (present invention, FIG. 7) and 72′ (prior art, FIG. 6) also move according to the movement of the throttle control mechanisms 92 and 82, respectively, as generally known in the art, to provide driving power to the chain.

It should be appreciated that the focus of this arced brake control is on pulling the brake cable around a periphery of the arced brake control, and, thus, it is not absolutely necessary that the brake cable be secured at the perimeter of the arced brake control so long as the length of cable is pulled by winding the length about the controller. A different type of connection is shown in FIGS. 1-5, wherein the cable is wound partially around the perimeter of the arced brake control in the normal off throttle position. “Winding,” in this context, entails any length of cable extending around the periphery, and it does not require that it actually wind 360 degrees around the arced brake control. Additionally, while a circular arced brake control is shown and is sufficient, other arcs, including cycloidal arcs, could be used and should be understood as being covered by the terms “arc” or “arced.” A cycloidal arc may lessen the finger fatigue to an even greater extent.

A second embodiment of this invention is particularly adaptable to chainsaws of a second type. Referring now to FIG. 8, a chainsaw (or power saw) in accordance with this invention is shown and designated by the numeral 110. Chainsaw 110 includes saw bar 111, about which saw chain 112 rotates. Handle frame 114 is secured to the main body of chainsaw 110, with front hand guard 116 located in front of it. Rear handle 118 is provided for gripping chainsaw 110 and providing access to throttle control trigger 120, which is shown in the normal off throttle position, at handle opening 123. Component cover plate 124 covers and/or houses (explained below) components controlling the advancement of saw chain 112 about saw bar 111. Cover plate 124 also covers and/or houses braking mechanisms to control saw chain 112. These braking mechanisms are actuated by front hand guard 116, when it is moved forward about pivot point 126, whether by inertia or by contacting the operator's arm positioned at handle frame 114. This is all conventional and well-known prior art, and will be known to those of ordinary skill in the art.

This second embodiment significantly alters the functioning of the brake band, particularly in relation to the brake drum and the throttle control trigger that is squeezed to power and advance the saw chain about the saw bar. More particularly, a spring bias acts on the typically stationary end of the brake band, and the brake band is associated to move when the throttle control mechanism is manipulated. Through practice of the present invention, the brake band is tightened or loosened about the brake drum according to the position of the throttle control trigger. Thus, the tightening of the brake band around the brake drum (and resultant braking of the chain) is not dependant only upon the activating of the kickback braking mechanism. Rather, in the present invention, the tightening and loosening of the brake band around the brake drum is dependant upon the squeezing and releasing of the trigger, when the kickback braking mechanism is not activated. However, the mechanisms used to associate the brake band with the trigger are independent of and do not frustrate the normal operation of the kickback braking mechanism. Even when the brake band is associated with the trigger as taught by this invention, the brake band may be caused to engage the brake drum and prevent the advancement of the saw chain about the saw bar by activating the kickback braking mechanism. Beneficially, in this invention, when the kickback braking mechanism is activated, there is no resultant shock to the trigger finger while the chainsaw is being operated in the on throttle position.

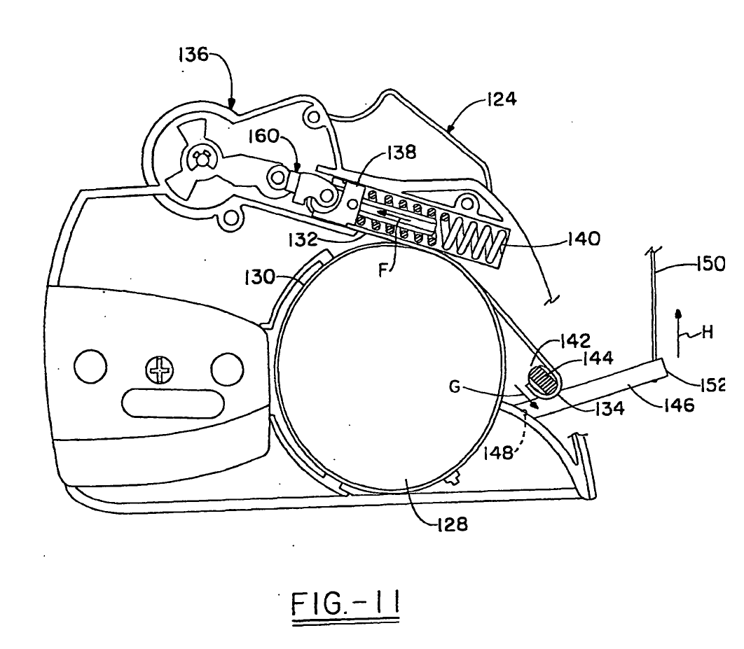

With reference to FIGS. 8 and 10, the present invention is described in its normal off throttle position. In FIG. 10, an outboard cover plate is shown removed from chainsaw 110 and turned to view the components carried thereby. These outboard type cover plates are well known, and carry the brake band and braking components of the kickback brake mechanism. It will be appreciated that the concepts and structural configurations disclosed here with respect to the outboard embodiment may be readily applied in an inboard embodiment. In either an inboard or outboard embodiment, brake drum 128 is provided in the main body of chainsaw 110, and brake band 130 fits there over. Squeezing trigger 120 rotates a centrifugal clutch that engages and rotates brake drum 128 and advances saw chain 112 about saw bar 111. If the brake drum 128 is stopped, then the saw chain 112 is also stopped. Brake band 130 is disposed around brake drum 128, and is secured to other components of chainsaw 110 at first movable end 132, and second movable end 134. First movable end 132 is connected to braking mechanism 136 at piston 138, which is biased in the direction of arrow F by compression spring 140. The position of piston 138 is limited by the interaction of other components of braking mechanism 136. In the position shown in FIG. 10, the kickback brake has not been activated and, in the prior art, this would allow brake band 130 to be loose enough on brake drum 128 to allow for the rotation of brake drum 128 and the advancement of saw chain 112. However, the present embodiment changes this general configuration, and provides a second movable end 134, where a stationary end is used in the prior art. As will be understood below, this allows for the independent braking and releasing of brake drum 128 by brake band 130, even when the kickback brake is not activated.

Second movable end 134 is biased from support 142 by spring 144, which urges second movable end 134 in the direction of arrow G. Spring 144 is strong enough to pull brake band 130 against brake drum 128 with enough force to prevent the movement of brake drum 128. Thus, when trigger 120 is in the normal off throttle position, saw chain 112 simply cannot be advanced about saw bar 111. This is much different than in the prior art, wherein it is common for an idling chainsaw to be seen with the saw chain advancing around the saw bar. By preventing such chain run down, this embodiment provides a safety benefit beyond that provided by the prior art.

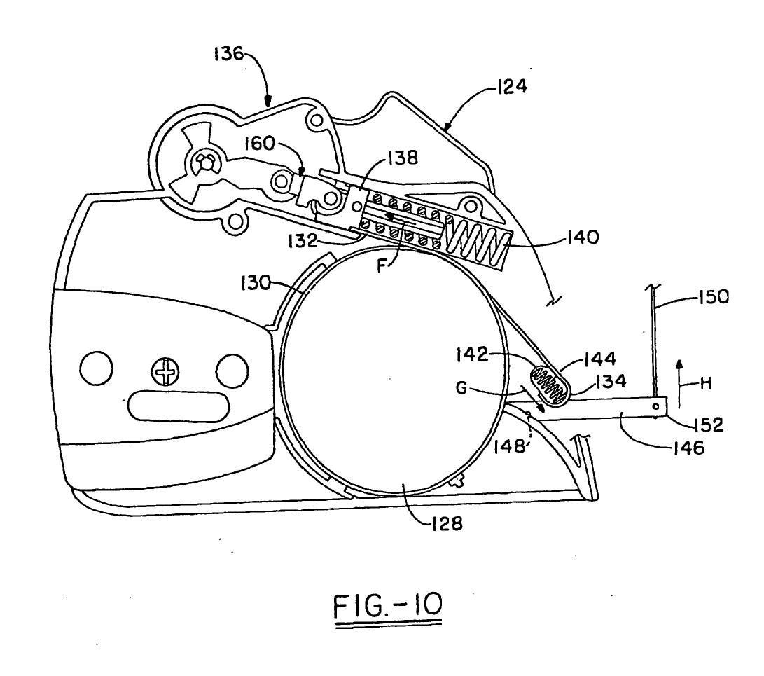

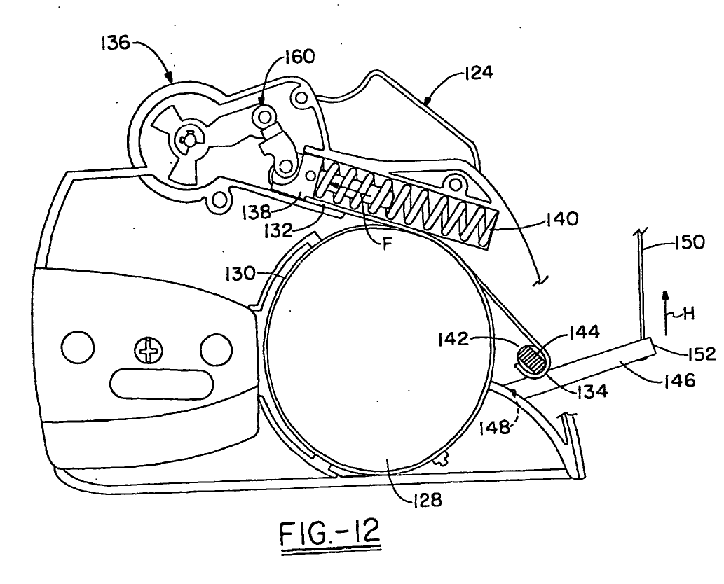

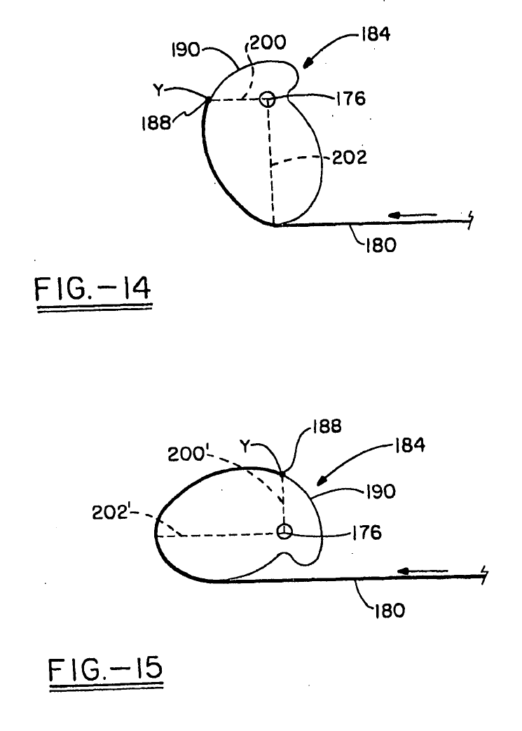

Second movable end 134 is functionally associated with trigger 120 such that movement of trigger 120 from the normal off throttle position (trigger not squeezed) to an on throttle position (trigger squeezed) will allow chain 112 to be advanced around saw bar 111 (i.e., will loosen brake band 130 from brake drum 128). Particularly, actuator bar 146 engages second movable end 134 to move the same when trigger 120 is squeezed by a chainsaw operator. Actuator bar 146 is secured to cover plate 124 at pivot point 148, and is secured to cable 150 at an opposite end 152 of actuator bar 146. Cable 150 is preferably a Bowden cable. Brake band 130 engages actuator bar 146 at some point between pivot point 148 and cable 150 such that movement of cable 150 in the direction of arrow H causes actuator bar 146 to press up against the bias of spring 144 against second movable end 134. It will be appreciated that this movement will loosen brake band 130 from brake drum 128. With reference to FIGS. 8-11, it will be appreciated that cable 150 is moved in the direction of arrow H through the squeezing of trigger 120 due to the fact that cable 150 is connected to move with trigger 120 after advancing around a support 154. Cable 150 could be secured to move with trigger 120 substantially as already described with respect to triggers 20 and 20′ and cables 76 and 76′ in FIGS. 6 and 7, and an arced brake control 155 is shown by way of example. Another method is described with respect to FIGS. 14 and 15. Squeezing trigger 120 (as seen in FIGS. 9 and 11), pulls cable 150 in the direction of arrow I about support 154, thus pulling the end connected to actuator bar 146 in the direction of arrow H. It will be appreciated that there is no physical gap shown between brake band 130 and brake drum 128 in FIG. 11 because the clearance is very small. Nevertheless, it will be understood that brake drum 128 will be permitted to rotate when second movable end 134 is moved against the bias of spring 144.

By connecting cable 150 to trigger 120, the on throttle position, wherein chain 112 may be advanced about saw bar 111, is achieved upon squeezing trigger 120 to provide the driving force to chain 112, and the braking position is achieved upon release of trigger 120. As known, throttle rod 151 is associated with trigger 120 and a carburetor 153 such that squeezing trigger 120 moves rod 151 and opens carburetor 153, and releasing trigger 120 moves rod 151 to close carburetor 153. Assuming that the kickback brake mechanism has not been activated, brake band 130 engages brake drum 128 to stop chain run down as the system is being throttled down, and the life of brake band 130 is thus extended, as wear on brake band 130 is reduced.

In accordance with another embodiment, cable 150 and throttle rod 151 are secured to move with trigger 120 such that, when trigger 120 is moved toward the throttle on position, brake band 130 is loosened from about brake drum 128 prior to the initiation of any gas feed through throttle rod 151 and carburetor 153. This ensures that there is no frictional wear between brake band 130 and brake drum 128. Similarly, cable 150 and throttle rod 151 would preferably be secured to trigger 120 such that, as trigger 120 is released to move to the throttle off position, gas feed through throttle rod 151 and carburetor 153 is shut off before contact is made between brake band 130 and brake drum 128. In such a configuration, the drum is not advanced against the brake band when the band is drawn taut on the drum and thus the life of the brake band is extended. This same concept is readily applied to electric chainsaws not employing carburetors, and those of skill in the art will readily appreciate the application of this concept to such chainsaws. Additionally, these concepts are applicable to the cables 76 and 76′ and throttle rods 72 and 72′ of the embodiment of FIGS. 1-7.

It should be appreciated that “actuator bar” is to interpreted very broadly because virtually any structure rotating about a pivot point may be used to press against the second movable end of the brake band. And although a particular pivot point and orientation was chosen for disclosure, other orientations and pivot points could be used to cause the actuator bar to contact the second movable end as desired.

In FIG. 12, the relevant components of a chainsaw in accordance with this invention are shown as they would be when a chainsaw operator is squeezing throttle control mechanism 120 (i.e., on throttle) and the kickback brake mechanisms 136 are activated through movement of front hand guard 116. When front hand guard 116 is contacted to activate braking mechanism 136, compression spring 140 moves piston 138 further in the direction of arrow F due to the movement at toggle joint mechanism 160. This moves first movable end 132 of brake band 130 into a position wherein brake band 130 is drawn tightly against brake drum 128 to stop the rotation of brake drum 128 and prevent further advancement of saw chain 112. Saw chain 112 is stopped despite the position of second movable end 134, which has been moved against the bias of spring 144 due to the squeezing of trigger 120. Due to the configuration employed here, wherein the trigger is isolated from the kickback brake mechanism, and the biasing elements of the kickback brake mechanism operate independently of the biasing element acting on the second movable end of the brake band, there is no shock to the trigger finger upon the activation of the kickback braking mechanism. It will be appreciated that other kickback brake mechanism configurations could be employed. It should also be appreciated that the connection between throttle control mechanism 120 and cable 150 can be configured as already described with reference to FIGS. 6 and 7.

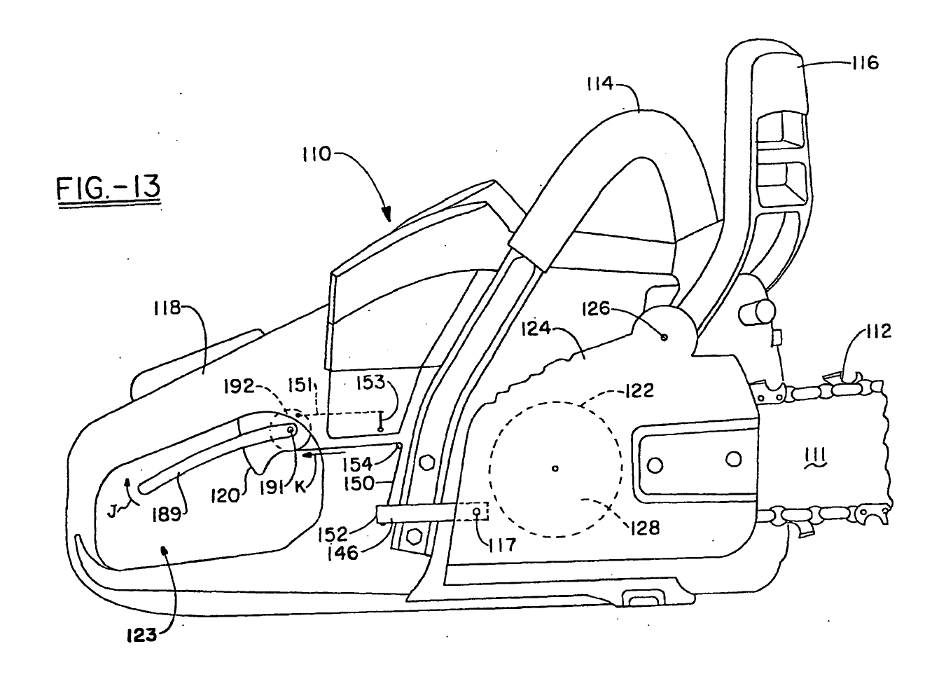

In an alternative embodiment generally depicted in FIG. 13, second movable end 134 of brake band 130 is associated with safety lever 189, which pivots at connection 191 on the frame of the chainsaw and extends along side or, preferably, around trigger 120 (with an appropriate aperture in safety lever 189 permitting the passage of trigger 120 therethrough). Cable 150 is connected to move with safety lever 189 rather than trigger 120, as in the prior disclosed embodiments. Moving and holding safety lever 189 in the direction of arrow J pulls cable 150 in the direction of arrow K, thus moving actuator bar 146 upwardly to loosen brake band 130 from brake drum 128. This permits chain 112 to be advanced about saw bar 111 upon the subsequent squeezing of trigger 120. If safety lever 189 is not moved and held in the direction of arrow J, chain 112 is braked and cannot advance about saw bar 111. When safety lever 189 is released, brake band 130 tightens about brake drum 120 to prohibit such advancement. Basically this embodiment operates as the previous embodiments, but decouples the trigger 120 and cable 150. A chainsaw operator would squeeze safety lever 189 with, for example, the middle, ring and pinky fingers, and thereafter use the index finger to squeeze the throttle control trigger 120. Cable 150 is shown connected to an arced brake control 192 to move as described, but other configurations can be employed, such as a lever arm-type connection as is FIG. 6. By decoupling the trigger and cable, it is possible to release the trigger without thereby causing an automatic braking of the chain. This can reduce wear and tear on the braking elements. This concept of providing a separate safety lever for associating with the braking mechanisms can be practiced with all embodiments disclosed herein, particularly, for example, by making the throttle trigger assembly of FIG. 3 as a separate safety lever about a common throttle trigger.

It should be appreciated that the focus of the arced brake control of FIG. 7 is on pulling the cable around a periphery of the arced brake control, and, thus, it is not absolutely necessary that the cable be secured at the perimeter of the arced brake control so long as the length of cable is pulled by winding the length about the controller. “Winding,” in this context, entails any length of cable extending around the periphery, and it does not require that it actually wind 360 degrees around the arced brake control. Additionally, while a circular arced brake control is shown and is sufficient, other arcs could be used and should be understood as being covered by the terms “arc” or “arced.” An arced brake control providing a non-round periphery resulting from having a variable radius may lessen the finger fatigue to an even greater extent.

Referring now to FIGS. 14 and 15, an arced brake control 184 is shown and can be seen to provide a variable radius. This particular arced brake control 184 is similar to the non-round, somewhat kidney-shaped pulleys employed in compound bows or in variable resistance machines, such as Nautilus™-type machines. Securing such an arced brake control 184 to a trigger lever in a chainsaw will permit the user to experience a variable resistance to the squeezing of the trigger. Advantageously, the control 184 can be shaped and positioned by the manufacturer to vary the resistance, as desired, throughout the range of trigger movement. The importance is on the variable radius aspect of the arced brake control, and this invention is not to be limited to any particular variable radius shape.

For example, as shown in FIGS. 14 and 15, an arced brake control 184 can be configured with a variable radius, as exemplified by the spiral pulley configuration thereof, and a cable ultimately associated with biased elements of the brake mechanism can be secured thereto at connection 188 at periphery 190. The cable is identified herein by the numeral 180. Cable 180 could be cable 76 of the embodiment of FIGS. 1-5 or cable 150 of the embodiment of FIGS. 8-13. It should be appreciated that the arced brake control concept exemplified by arced brake control 184 can be applied to other chainsaw embodiments wherein a cable must be manipulated by a trigger element. Cable 180 extends around periphery 190, which is defined by a variable radius emanating from pivot point 176, to then extend away from arced brake control 184, at a tangent thereto. Cable 180 will ultimately connect to a spring biased element, usually associated with the mechanisms braking the brake drum of the chainsaw. A trigger, such as trigger 20 of FIGS. 6 and 7, could be directly secured to arced brake control 184, at pivot point 176 such that movement of the trigger results in an identical degree of movement in arced brake control 184, or, alternatively, the trigger might connect to arced brake control by gearing such that a lesser movement of the trigger results in a greater movement of arced brake control 184.

At the beginning of a trigger squeeze cycle, which is defined therein as the squeezing of the trigger from the full off-throttle position to the full on-throttle position, the trigger might be relatively difficult to squeeze due to the short user lever arm 200 provided by arced brake control 184 for the advantage of the user, and the larger load lever arm 202, which is to the advantage of the load being pulled. In the embodiment of a chainsaw as in FIGS. 1-5, it is the load of spring 44 acting on actuator bar 46 that provides resistance to trigger movement through load lever arm 202, but it will be appreciated that the arced brake control concepts herein can be applied to act against the resistance to trigger movement provided in other chainsaw configurations. As the user rotates arced brake control 184 through squeezing of the trigger, the user lever arm acting to the advantage of the user gradually increases in length (see 200′ in FIG. 9), while the load lever arm acting to the advantage of the load gradually decreases in length (see 202′ in FIG. 9). As a result, the trigger becomes increasingly easier to squeeze. It should be appreciated that the user's trigger finger is typically stronger in the more extended position that it is in at the beginning of the trigger squeeze cycle, and is typically weaker at the end (full throttle) of the cycle, and the particular configuration of arced brake control 184 can decrease finger fatigue because it makes it easier to hold a chainsaw at full throttle for longer periods of time.

The orientation shown in the Figures is for demonstration only, and it should be appreciated that, although a rotation of 90 degrees has been used to demonstrate the invention, lesser or greater rotations of an arced brake control might be practiced. With appropriate gearing between the trigger and arced brake control, one could develop a trigger system wherein a small rotational movement of the trigger lever would result in a greater rotational movement of the arced brake control, thus taking advantage of the variable radius to an even greater degree. Given a desired trigger swing length, those of skill in the art will be able to choose desired configurations and gearing mechanisms.

Although gas-driven chainsaws are the focus of the preferred embodiments herein, it should be appreciated that all of the teachings herein are readily applicable to electric chainsaws, with such application being readily apparent to those of skill in the art. Nothing herein is to be read to limit the application of the concepts herein to a gas-driven system.

From the foregoing, it should be clear that the various embodiments of this invention provide many improvements to chainsaws, their braking mechanism and throttle control mechanisms. While a full and complete description of the invention has been set forth in accordance with the dictates of the patent statutes, it should be understood that modifications can be resorted to without departing from the spirit hereof. This invention is not to be limited to the preferred embodiments disclosed herein. The claims will define the invention.

What is claimed is:

1. A chainsaw comprising:
a brake drum;
a saw bar;
a saw chain disposed about said saw bar, wherein said brake drum rotates as said saw chain is advanced about said saw bar, and preventing said brake drum from rotating prevents said saw chain from advancing about said saw bar;
a brake band disposed around said brake drum and having a first movable end that is associated with a first biasing member and a second movable end that is biased by a second biasing member to draw said brake band against said brake drum and thereby prevent the rotation of said brake drum; and
a throttle control trigger movable between an off throttle position and an on throttle position;
an actuator bar secured to pivot about a pivot point; and
a cable secured at one end to move with said throttle control trigger and secured at an opposed end to said actuator bar, said second movable end of said brake band being positioned in close proximity to said actuator bar, wherein, when said throttle control trigger is moved from said off throttle position to said on throttle position, said cable pulls on said actuator bar so that said actuator bar pivots about said pivot point and contacts and moves said second movable end against said second biasing member, thereby loosening said brake band from said brake drum and permitting the rotation of said brake drum, and, when said throttle control trigger is moved from said on throttle position to said off throttle position, said second movable end is moved by said second biasing member to draw said brake band against said brake drum and thereby prevent the rotation of said brake drum.

2. The chainsaw of claim 1, wherein a mechanism providing said biasing force is positioned between said second movable end of said brake band and a stationary support.

3. The chainsaw of claim 1, wherein said biasing force on said second movable end is a spring.

4. The chainsaw of claim 1, wherein said throttle control trigger is part of a throttle control mechanism having an arced brake control that rotates about a pivot point when said throttle control trigger is moved between said off throttle and said on throttle positions, and said second movable end of said brake band is operatively associated with said arced brake control through said cable such that moving said throttle control trigger from said off throttle position to said on throttle position causes a portion of said cable to be wound about a periphery of said arced brake control.

5. The chainsaw of claim 1, further comprising a kickback brake mechanism, wherein said first movable end of said brake band is associated with said kickback brake mechanism.

6. The chainsaw of claim 5, wherein activating said kickback brake mechanism moves said first movable end of said brake band to draw said brake band against said brake drum, despite the position of said throttle control trigger and said second movable end.

7. The chainsaw of claim 6, wherein said second movable end is biased away from a support, said second biasing member is a spring, and activating said kickback brake mechanism draws said second movable end against said biasing member to be stopped by said support.

8. The chainsaw of claim 1, wherein said second movable end is positioned between said pivot point of said actuator bar and the connection point of said cable secured thereto.

9. A chainsaw comprising:
a throttle control trigger rotating at a pivot point between an off throttle position and an on throttle position;
an arced brake control associated with said throttle control trigger;
a cable secured to said arced brake control such that rotation of said throttle control trigger from said off throttle position to said on throttle position causes a portion of said cable to be wound on a perimeter of said arced brake control.

10. A chainsaw as in claim 9, wherein said arced brake control has a variable radius measured from a pivot point thereof to said perimeter thereof; wherein a bias on said cable causes it to resist being wound on said perimeter of said arced brake control, and said arced brake control, due to its variable radius, makes such resistance variable as said throttle control trigger is rotated from said off throttle position to said on throttle position; and wherein said pivot point of said throttle control trigger may be the same or different than the pivot point of said arced brake control.

11. A chainsaw comprising:
a brake cable; and
a throttle control mechanism including:
a throttle control trigger rotating at a pivot point between an off throttle position and an on throttle position,
a freewheeling cam providing a ratchet tooth, wherein said brake cable is secured to said freewheeling cam; and
an actuator arm associated with said throttle control trigger to rotate therewith, said actuator arm engaging said ratchet tooth of said freewheeling cam such that rotation of said throttle control trigger from said off throttle position to said on throttle position causes movement of said freewheeling cam through the engagement with said actuator arm, and movement of said freewheeling cam causes movement of said brake cable.
